(19) United States
(12) Patent Application Publication
(10) Pub. No.: US 2010/0117352 A1
(43) Pub. Date: May 13, 2010

(54) CONNECTING ARRANGEMENT FOR A PIPE UNION

(75) Inventor: Norbert Felder, Hennef (DE)

Correspondence Address: COLLARD & ROE, P.C., 1077 NORTHERN BOULEVARD, ROSLYN, NY, 11576, US

(73) Assignee: WEIDMANN LTD., Troisdorf (DE)

(21) Appl. No.: 12/452,156

(22) PCT Filed: Jun. 18, 2007
(86) PCT No.: PCT/EP2007/056016

§ 371 Date: Dec. 30, 2009

(51) Int. Cl. F16L 55/00

(52) U.S. Cl. 285/24

(57) ABSTRACT

A connecting arrangement connects a cylindrical pipe (10) or a pipe section to a connecting body (20). The connecting body (20) has a first conical bore (23), extending away from a face (24), a first cylindrical bore (21) for receiving the pipe (10), which bore is contiguous to the conical bore (23), and a second cylindrical bore (22) that is contiguous to the first cylindrical bore (21) and the diameter of which is reduced. A union nut (30) has a bore (31) for the pipe (10) or the pipe section. The union bore has a threaded section (38) by means of which the union nut (30) can be screwed onto a mating threaded section (28) of the connecting body (20), and a conical bore (33) that tapers in a direction opposite to that of the conical bore (23) of the connecting body (20). A cutting ring (40) has a first tapered section (42). The tapered section (42) sits in the conical bore (33) of the union nut (30). The cutting ring (40) has a bore (46) for passing the pipe (10) or the pipe section through and at least one radial peripheral blade (41, 42) that faces the pipe (10) or the pipe section. An intermediate ring has a bore (51) for the pipe (10) or the pipe section. The intermediate ring (50) is interposed between the cutting ring (40) and the connecting body (20). The intermediate ring (50) has a conical bore (43) against which a second tapered section (44) of the cutting ring (40) presses. The cutting ring (40) is slotted parallel to the axis of the pipe (10) (slotted section 47).

The invention relates to a connecting arrangement for connecting a cylindrical pipe or pipe section to a connecting body, whereby the connecting body has a first conical bore that proceeds from a face surface, a first cylindrical bore that follows the conical bore, to accommodate the pipe, and a second cylindrical bore that follows the first cylindrical bore and is reduced in diameter, with a union nut that has a bore for the pipe or pipe section, with a thread with which the union nut can be screwed onto a counter-thread of the connecting body, and with a conical bore that narrows opposite to the conical bore of the connecting body, with a cutting ring that has a first cone, which sits in the conical bore of the union nut, which cutting ring has a bore for passing the pipe or pipe section through and at least one radially circumferential blade, which face the pipe or pipe section, and with an intermediate ring that has a bore for the pipe or pipe section, which ring is disposed between the cutting ring and the connecting body, and which intermediate ring has a conical bore that presses against a second cone of the cutting ring.

Pipe unions are supposed to become possible with such connecting arrangements. In this connection, a pipeline, particularly a metallic one, is supposed to be connected to a connecting piece that has an accommodation opening for the pipeline. A union nut that can be screwed together with the connecting piece can be turned while being connected, and thus exerts an axial movement on a cutting ring that is situated between the union nut and the connecting piece. By means of disposing different conical bores and counter-pieces that sit in them, the axial movement is transferred to a cutting ring having a blade, in such a manner that when the union nut is tightened, a deformation radially toward the inside takes place in certain sections. A cutting edge then cuts into the material of the pipeline, with shape fit and with a notch effect.

Such concepts are known, for example, from DE 196 37 129 C2 or EP 0 863 354 B1. These and other concepts are also used in practice in many ways.

It is problematic that because of the plurality of the small elements that can move relative to one another, which all surround the pipe to be connected in ring shape, a relatively great amount of force must be exerted to assure the different deflection movements.

In contrast with this, it is the task of the invention to propose a connecting arrangement for pipe unions that can be screwed together with little expenditure of force, without any loss in reliability and functionality for the user.

This task is accomplished, in the case of a connecting arrangement of the stated type, in that the cutting ring is slit parallel to the axis of the pipe.

The task is surprisingly accomplished in this way. The cutting ring does not lose any of its functionality as the result of the slit. It continues to possess a circumferential blade that can cut into the outer surface of the pipe, with a notch effect. The slit does not change this. However, the cutting ring becomes significantly more easily deformable in the radial direction. It offers practically no resistance to corresponding forces and movements any longer. This means that clearly reduced forces occur for the user during assembly of the connecting arrangement, in other words when screwing the union nut onto the thread of the connecting body.

In order to implement this effect of the slit cutting ring particularly well, specific values for the different angles have proven to be particularly practicable.

Thus, it is preferred if the cone angle of the second cone of the cutting ring and the cone angle of the conical bore of the intermediate ring amount to more than 20°, in each instance, particularly about 30° (±)5°.

In particular, much more precise radial cutting furthermore becomes possible in this way. Conversion of the axial forces when screwing the union nut on into radial forces for allowing the cutting blades to cut into the outer surface of the pipe takes place in significantly more precise manner.

Conventionally, the cone angle of the second cone of the cutting ring has usually been set at about 12°. However, because of the preferred characteristics, a cone angle in a range around 30° occurs in the new cutting ring. This means that at the same axial paths during joining of the connecting arrangement according to the invention, the cutting ring now cuts clearly deeper, and thus a significantly more reliable connection is formed. According to deliberations, the connection should now be better by a factor of about 2.8 than the one from the state of the art.

In a closer consideration with numerical examples, 1 mm axial path, for example, corresponds to a distance of 0.21 mm radial path at a conventional cone angle of 12°, while in the case of a configuration of the cone angle according to the invention, at 30°, the 1 mm axial path becomes a radial path of 0.57 mm.

One can think of this as meaning that the new concept according to the invention leads to the result that the cutting ring is clearly deformed more in the radial direction because of the steeper angle than in the case of the conventional designs with their flatter cone angles on the cutting rings. Thus, the cutting ring now cuts into the pipe material better, according to the invention.

Because significantly more precise and reliable radial cutting of the cutting ring now takes place, tolerances of the cutting ring are also balanced out better. The diameter tolerance of the cutting ring, for example, becomes significantly more tolerant of errors, so that the overall effect becomes even more reliable.

Because the cutting ring also clearly cuts better radially, not only the diameter tolerance but also the blade rounding become clearly more tolerant of errors and more reliable.

Likewise, it is preferred if the intermediate ring has a contact limitation surface, the cutting ring has a support surface that corresponds to the contact limitation surface, on the side adjacent to the intermediate ring, and the contact limitation surface and the conical bore of the intermediate ring enclose an angle with one another.

The concept also has other advantages. This is because the special arrangement of the intermediate ring makes it possible to separate the function of cutting and holding from a function of sealing that is also preferably desired.

This preferably takes place in that the intermediate ring has a soft sealing element that is disposed between the wall of the pipe, the intermediate ring, and the conical bore of the connecting body, surrounding the pipe.

This holds true particularly preferably if the soft sealing element is separated from the cutting ring by means of the intermediate ring that lies against the pipe on the outside.

It is furthermore particularly preferred if the dimensions of the cutting ring and of the intermediate ring are dimensioned to be so great that after assembly is complete, the cutting ring lies on the contact limitation surface of the intermediate ring with its support surface (and on the outside of the pipe with the surface that carries the blades.

This specifically allows clear signaling of the end of assembly, namely when the cutting ring lies on the intermediate ring. In this manner, over-assembly of the cutting ring can be precluded.

In total, the axial path of the union nut and of the cutting ring is now optimally converted to a radial path, according to the invention. Cutting by the cutting ring is clearly improved. This is supported with optimized angles.

It is furthermore preferred if blade rounding is provided. With blade rounding, the risk of the pipe tearing out is reduced, in other words the risk of unintentional loosening of the connecting arrangement due to the exertion of great forces. After all, it must be considered that when such events occur, the entire forces have to be absorbed by the blade.

An exemplary embodiment of the invention will be explained in greater detail in the following, using the drawing. This shows:

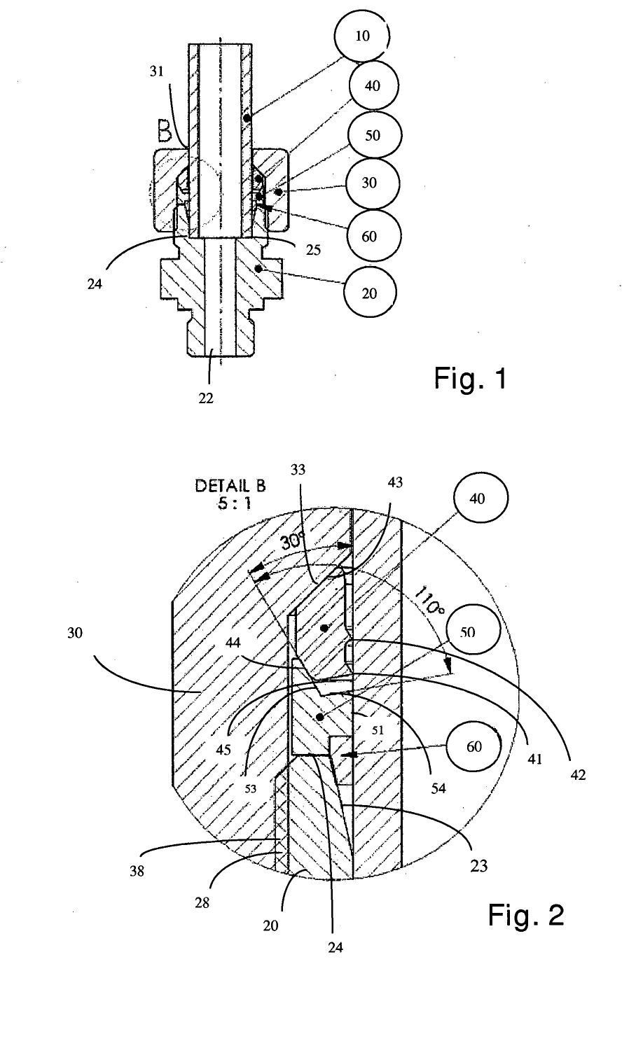

FIG. 1 a section through an embodiment of a connecting arrangement according to the invention;

FIG. 2 an enlarged representation of a detail from FIG. 1;

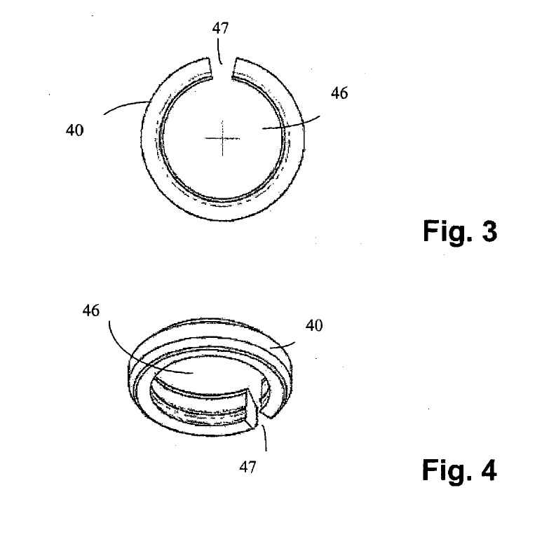

FIG. 3 a top view of a cutting ring according to the invention; and

FIG. 4 a perspective representation of the cutting ring from FIG. 3.

A pipe union of a pipe 10 with a connecting body 20 is explained in greater detail in FIG. 1. The pipe 10 is cylindrical; in FIG. 1, a bottom end of the pipe 10, which can be significantly longer and could also be part of a pipeline arrangement, is shown as an example.

This pipe 10 is inserted into a connecting body 20. For this purpose, the connecting body 20 possesses a first cylindrical bore 21, which is precisely dimensioned so that the pipe 10 can be inserted there. A second bore 22 is provided with a smaller diameter. This second bore 22 continues the first bore in the direction of the interior of the connecting body 20. A medium situated in the interior of the pipe 10 can thus get into the second bore 22 and be conveyed further there.

In this connection, the pipe 10 supports itself on a face surface 25, which separates the first bore 21 and the second bore 22 from one another.

Another face surface 24 is provided as the outer surface of the connecting body 20; in this connection, the first, outer cylindrical bore 21 makes a transition into a conical bore 23 that opens in the direction of the face surface 24.

On the outside the connecting body 20 also has a thread 28, which is equipped for forming a screw connection with a counter-thread 38 that will still be described further in the following.

Specifically, a union nut 30 having the counter-thread 38 can be screwed onto the thread 28 of the connecting body 20. The union nut 30 possesses a bore 31 through which the pipe 10 can be guided. Between the bore 31 and the thread 38, another section is provided, in which the bore through the union nut 30 widens in the direction toward the connecting body 20, as a conical bore 33.

Between the connecting body 20 and the union nut 30, there is a cutting ring 40. This cutting ring 40, in the embodiment shown, possesses two circumferential blades 41 and 42, which are directed in the direction of the outer surface of the pipe 10, in each instance. The cutting ring 40 surrounds the pipe 10, which projects through a bore 46 of the cutting ring.

The cutting ring 40 furthermore possesses a first cone 43, which is directed against the union nut 30 and sits in the conical bore 33 of the union nut 30 during assembly.

The cutting ring 40 furthermore possesses a second cone 44, which narrows in the direction opposite to the first cone 43.

An intermediate ring 50 is disposed between the cutting ring 40 and the connecting body 20. This intermediate ring 50 also possesses a bore 51 for the pipe 10 and surrounds this pipe 10. The intermediate ring 50 can also be referred to as an adapter element or as a holding ring.

This intermediate ring 50 possesses a circumferential support surface 52 with which it lies on the face surface 24 of the connecting body 20.

Furthermore, it possesses a conical bore 53 on the side facing away from this support surface 52. The second cone 44 of the cutting ring 40 sits in this conical bore 53.

This conical bore 53 borders on and makes a transition into a contact limitation surface 54 of the intermediate ring 50, adjacent to the bore 51 of the intermediate ring 50.

Opposite this contact limitation surface 54 lies a support surface 45 of the cutting ring 40, which at first still has a distance from this contact limitation surface.

The intermediate ring 50 furthermore carries a soft sealing element 60. This soft sealing element 60 is situated between the outer wall of the pipe 10, the conical bore 23 of the connecting body 20, and a corresponding carrying device of the intermediate ring 50. Since the intermediate ring 50 also borders on the outer wall of the pipe 10, the soft sealing element 60, which also runs around the pipe 10, is permanently mechanically separated from the cutting ring 40.

The enlarged representation of Detail B in FIG. 2 shows, in particular, what angles the conical bores have and what the approximate size ratios of the individual elements relative to one another are.

Again, the wall of the pipe 10, the consecutive regions of the connecting body 20, of the intermediate ring 50 with the soft sealing element 60, of the cutting ring 40, and furthermore of the union nut 30 can be clearly seen.

The cutting ring 40 can be seen particularly well in FIG. 3, in a top view. One can see here that it is not a continuous, closed ring that surrounds the bore 46, but rather that it has a slit 47. As a result, it is significantly more easily deformable radially, even when it is laid around the pipe 10.

Perspectively, one can see in FIG. 4 what the structure of the slit 47 is and how it behaves relative to the cone-shaped regions.

During assembly of a pipe 10 to the connecting body 20, the union nut 30, with the cutting ring 40 and the intermediate ring 50 situated on it, is pushed into the pipe from below, this pipe is then inserted into the connecting body 20, and afterwards, screwed on by way of the union nut 30.

The rings situated in it assume their position on their own, since the conical bores 23, 33, and 53 precisely match the cone-shaped elements 43 and 44.

By means of screwing the union nut 30 on, the small gap that at first exists between the support surface 45 on the cutting ring 40 and the contact limitation surface 54 on the intermediate ring 50 is closed, but at the same time, over-assembly of the cutting ring 40 is thereby prevented.

### REFERENCE SYMBOL LIST

10 pipe (cylindrical)

20 connecting body

21 bore (first cylindrical bore for the pipe 10)

22 bore (second, having a smaller diameter)

23 conical bore

24 face surface, against the intermediate ring

25 face surface, against the pipe 10

28 thread for screw connection with union nut 30

30 union nut

31 bore for the pipe 10

33 conical bore

38 thread for a screw connection with connecting body 20

40 cutting ring

41 first blade (circumferential)

42 second blade (circumferential)

43 first cone against union nut 30

44 second cone against intermediate ring 50

45 support surface against intermediate ring 50

46 bore for the pipe 10

47 slit

50 intermediate ring

51 bore for pipe 10

52 support surface against connecting body 20

53 cone for cutting ring 40

54 contact limitation surface for cutting ring 40

60 soft sealing element

1. Connecting arrangement for connecting a cylindrical pipe (10) or pipe section to a connecting body (20), whereby the connecting body (20) has a first conical bore (23) that proceeds from a face surface (24), a first cylindrical bore (21) that follows the conical bore (23), to accommodate the pipe (10), and a second cylindrical bore (22) that follows the first cylindrical bore (21) and is reduced in diameter,
with a union nut (30) that has a bore (31) for the pipe (10) or pipe section, with a thread (38) with which the union nut (30) can be screwed onto a counter-thread (28) of the connecting body (20), and with a conical bore (33) that narrows opposite to the conical bore (23) of the connecting body (20),
with a cutting ring (40) that has a first cone (42), which sits in the conical bore (33) of the union nut (30), which cutting ring (40) has a bore (46) for passing the pipe (10) or pipe section through and at least one radially circumferential blade (41, 42), which face the pipe (10) or pipe section, and with an intermediate ring (50) that has a bore (51) for the pipe (10) or pipe section, which ring is disposed between the cutting ring (40) and the connecting body (20), and which intermediate ring (50) has a conical bore (53) that presses against a second cone (44) of the cutting ring (40),
wherein
the cutting ring (40) is slit parallel to the axis of the pipe (10) (slit 47), wherein the intermediate ring (50) has a contact limitation surface (54), wherein the cutting ring (40) has a support surface (45) that corresponds to the contact limitation surface, on the side adjacent to the intermediate ring (50), and wherein the contact limitation surface (54) and the conical bore (53) of the intermediate ring (50) enclose an angle of 110° (±5°) with one another.

2. Connecting arrangement according to claim 1,
wherein
the cone angle of the second cone (44) of the cutting ring (40) and the cone angle of the conical bore (53) of the intermediate ring (50) amount to more than 20°, in each instance, particularly about 30° (±5°).

3-4. (canceled)

5. Connecting arrangement according to
claim 1, wherein
the intermediate ring (50) has a soft sealing element (60), and wherein the soft sealing element (60) is disposed between the wall of the pipe (10), the intermediate ring (50), and the conical bore (23) of the connecting body (20), surrounding the pipe (10).

6. Connecting arrangement according to claim 5,
wherein
the soft sealing element (60) is separated from the cutting ring (40) by means of the intermediate ring (50) that lies against the pipe (10) on the outside.

7. Connecting arrangement according to
claim 1, wherein
the dimensions of the cutting ring (40) and of the intermediate ring (50) are dimensioned to be so great that after assembly is complete, the cutting ring (40) lies on the contact limitation surface (54) of the intermediate ring (50) with its support surface (45) and on the outside of the pipe (10) with the surface that carries the blades (41, 42).

8. Connecting arrangement according to
claim 1, wherein
the cutting ring (40) is equipped with blade rounding.
